(19) United States
(12) Patent Application Publication
(10) Pub. No.: US 2001/0032148 A1
(43) Pub. Date: Oct. 18, 2001

(54) System of and method for exchanging information on commercial transaction exploiting electronic catalog and system of and method for collecting and storing marketing information

(76) Inventors: Katsuo Yamazoe, Tokyo (JP); Daisuke Taduru, Tokyo (JP)

Correspondence Address: HELFGOTT & KARAS, P.C., EMPIRE STATE BUILDING, 60TH FLOOR, NEW YORK, NY, 10118, US

(21) Appl. No.: 09/816,871

(22) Filed: Mar. 22, 2001

(30) Foreign Application Priority Data
Mar. 23, 2000 (JP) 2000-082421

(51) Int. Cl. G06F 17/60

(52) U.S. Cl. 705/26

(57) ABSTRACT

A system method for exchanging the information on commercial transactions exploiting an electronic catalog comprising:

(a) collecting electronic catalog information on articles of commerce supplied by a seller;

(b) retrieving said catalog information responsive to a request for retrieval of an article of commerce from a purchaser to notify the results of retrieval to said purchaser;

(c) notifying an estimation reply for the article of commerce to said purchaser responsive to the estimation reply of the articles of commerce from the purchaser; and

(d) notifying reception of an order for an article of commerce from purchaser to said seller and for notifying the due term for delivery and/or the state/condition of shipment of the article of commerce to said purchaser, as necessary, based on the information from said seller. The system comprises a server system, a client terminal of a seller and a client terminal of a purchaser, both connected over a network.

### FIELD OF THE INVENTION

This invention relates to a system and a method for carrying out marketing operations efficiently using a network such as Internet. More particularly, it relates to a system and a method retained to be optimum in negotiations in the E-commerce and in order accepting operations, and to a computer-readable program, e.g., carried on a medium, for carrying out the method or the system.

### BACKGROUND OF THE INVENTION

In a marketing operation for articles of commerce, represented by business sections of an enterprise, there arise an act of dealing (negotiation) for selecting an article of commerce and deciding the pricing; and an act of deciding an article of commerce to be purchased and placing an order in the process of a customer purchasing an article of commerce.

For a selling party, it is ideal to make sale efficiently at a reasonable price to as many channels as possible. To this end, attempts and artifices are extended to do an act of dealing for new and old customers to collect and analyze market needs to propose articles of commerce matched to the needs and reasonable prices in order to acquire a new order of articles of commerce from the customers.

Up to now, the marketing operations are routinely going on in the following configuration:

Among acts performed for carrying out variegated business activities and instigating the desire on the part of customers in purchasing the articles of commerce, there are visits by those in charge of business on the premises of the customers, distribution of ads or catalogs of the articles of commerce, direct mails, telephone or facsimile (FAX) transmission.

If the customers are willing to purchase an article of commerce, negotiations are conducted as to the condition of transaction, such as price and due date, in the form of a visit by those taking charge of business, telephone, FAX or mails.

The intention of the customer in placing an order then is received. This is done by visits by those taking charge of business, other visits, telephone, FAX or mails. On receipt of the order from the customer, liaison is made to related sect ions, using communication means, such as telephone, FAX or an intra-company system.

### SUMMARY OF THE DISCLOSURE

However, the above-mentioned conventional marketing system has the following drawbacks:

On the selling side, these drawbacks include:

1. limits placed on the chance of sale;

2. an increased cost in a catalog of articles of commerce,

3. an increased number of steps in collecting, accumulating and analyzing the marketing information;

4. an increased lead time and increased number of steps in estimation, inquiry, reply, order acceptance, and so forth.

On the purchasing side, the following drawbacks are encountered:

1. an increased number of steps in retrieving articles of commerce;

2. an increased lead time involving an increased number of steps in estimation, inquiry, reply and order issue and acceptance, and so forth.

It is therefore an object of the present invention to provide a system and a method for reducing the lead time involved in negotiations and order acceptance in the sale business of an enterprise to improve the efficiency, and a computer-readable program product corresponding to the method or the system.

It is another object of the present invention to provide a system and a method for enabling efficient collection of the marketing information and a program product corresponding to the method or the system.

According to a first aspect of the present invention, there is provided a system for exchanging the information on commercial transactions exploiting an electronic catalog comprising: means for collecting the catalog information, rendered in an electronic form, of the information on articles of commerce supplied by a seller; means for retrieving the catalog information responsive to a request for retrieval of an article of commerce from a purchaser to notify the results of retrieval to the purchaser; means for notifying an estimation reply for the article of commerce to the purchaser responsive to the estimation reply of the articles of commerce from the purchaser; and means for notifying reception of an order for an article of commerce from the purchaser to the seller and for notifying the due term for delivery and/or the state/condition of shipment of the article of commerce to the purchaser, as necessary, based on the information from the seller.

According to a second aspect of the present invention, there is provided a system for exchanging the information on commercial transactions exploiting an electronic catalog comprising:

(a1) a server system;

(a2) a client terminal of (a3) a seller and a client terminal of a purchaser, both connected over a network to the server system;

(b) means provided on the seller for storing the catalog information of the information on marketed articles of commerce, rendered in an electronic form; and

(c) means provided on the server system for automatically collecting the electronic catalog information, retrieving means, estimating means, ordering means and a database;

(d) the purchaser asking the retrieval means of the server system a request for retrieving a catalog of articles of commerce from the client terminal of the purchaser;

(e) the retrieving means retrieving the catalog information, with retrieved results being transmitted to the client terminal of the purchaser for display;

(f) the purchaser transmitting an estimation request of articles of commerce from the client terminal to the estimation means of the server system;

(g) the estimation means, on receipt of the estimation request making a reply as to the estimation of the article of commerce, or a person of the seller in charge inputting contents of the reply of the estimation, by way of making a reply, with the estimation reply being transmitted through the estimation means to the client terminal of the purchaser;

(h) the purchaser, on receipt of the estimation reply, transmitting ordering data, in placing an order for an article of commerce, from the client terminal of the purchaser to the ordering means of the server system;

(i) the ordering system transmitting data to the seller as the E-commerce information of a preset form, the ordering system receiving the information on the due term for delivery and the state/conditions of shipment output from the seller for storage in the database, the ordering system also making a reply on the due term for delivery and displaying the state/conditions of shipment on request from the purchaser.

In the present invention, the system proper includes at least one system which is capable of coping with a configuration comprised of one selling enterprise to N purchasing enterprises, where N is a preset integer not less than 1. Alternatively, the system proper is comprised of one system which is capable of coping with a configuration comprised of M selling enterprises to N purchasing enterprises, where N and M are each a preset integer not less than 2.

In a third aspect of the present invention, there is provided a method for exchanging the information on the commercial transaction exploiting an electronic catalog comprising:

(a) a step of a seller generating the catalog information corresponding to the information on the articles of commerce on sale, the catalog information being in an electronic form;

(b) a step of a server system automatically collecting the catalog information in the electronic form;

(c) a step of a purchaser asking the retrieving function of the server system from a client terminal to retrieve a catalog of the articles of commerce desired to be purchased and receiving the result of catalog retrieval by the retrieving function;

(d) a step of the purchaser asking the retrieval function of the server system from the client terminal to make estimation of the articles of commerce desired to be purchased;

(e) a step of the server system making a reply on the estimation of the article of commerce responsive to the request for estimation by the purchaser or of a person of the seller in charge inputting contents of the reply on the estimation by way of making a reply;

(f) a step of the purchaser of the article of commerce or the purchaser receiving the reply on the estimation in ordering the article of commerce transmitting ordering data from the client terminal to the ordering mechanism of the server system;

(g) a step of the ordering function of the server system transferring the ordering data as preset E-commerce information to the seller;

(h) a step of the server system receiving the information on the due term for delivery or the state/conditions of shipment output from the seller to store the received information on the due term for delivery or the state of shipment in a database and displaying the reply on the due term for delivery or the state of shipment responsive to the request by the purchaser.

Still further aspects and features of the present invention are also disclosed in the entire claims as appended, which contents are incorporated herein by reference thereto.

### BRIEF DESCRIPTION OF THE DRAWINGS

FIG. 1 illustrates an embodiment of the present invention.

FIG. 2 illustrates a system configuration of the embodiment of the present invention.

### PREFERRED EMBODIMENTS OF THE INVENTION

The present invention provides a novel business model which renders the marketing operations in a business branch of an enterprise more efficient through the use of the Internet. More specifically, in the system of the present invention for negotiations and for the ordering/order accepting system in an E-commerce employing the present invention,

i) it is possible for a selling company to efficiently register the information on the articles of commerce (electronic catalog) on an application service on a network managed by a dealer in offering connection services on the Internet (Internet service provider) on a database on an application having a WWW (World Wide Web) voluntarily managed by the selling enterprise arranged on a front server, through the use of the XML (extensible markup language);

ii) while it is possible for a customer permitted by authorization to promptly retrieve and reference to the registered information over the Internet;

iii) an inquiry may be made as to estimation, due term for delivery and inventory and reply may also be made on the referenced article of commerce; and

iv) the order accepting information registered by the customer, pursuit for instantaneousness in business operations by automatic E-mail distribution following information registration, and efficient execution of marketing operations by the business sampling of the electronic catalog access log or estimation hysteresis supporting by referencing, may be achieved efficiently.

The system configuration of the present invention includes a system proper having a WWW server and a data base and provided with the functions of retrieval, estimation and ordering, and a client terminal of a selling enterprise and a client terminal of a purchasing enterprise, both connected to the system over the network.

The selling enterprise includes means for generating an electronic catalog in which to store the catalog information of articles of commerce to be on sale.

The system includes means for automatically collecting the generated electronic catalog.

The purchasing enterprise asks the retrieval means of the system for retrieval of a catalog for articles of commerce desired to be purchased so as to receive the retrieved results. The purchasing enterprise asks the estimation means of the system to make estimation of the article of commerce desired to be purchased. The estimation means of the system is responsive to this request for retrieval from the purchasing enterprise to make a reply as to the estimation of the article of commerce in the estimation means of the system, or the person of the selling enterprise in charge inputs the contents of the estimation reply by way of a reply to transmit the reply to the client terminal of the purchasing enterprise through the estimation means of the system.

The purchasing enterprise receives the estimation reply and, in case the reply meets the purchasing requirements, transmits the ordering data to the ordering means of the system as being the preset E-commerce information. The purchasing enterprise also receives the information on the due term for delivery and the state of shipment output by the selling enterprise for storage in the database and is responsive to the request of the purchasing enterprise to display the due term for reply and the state of shipment.

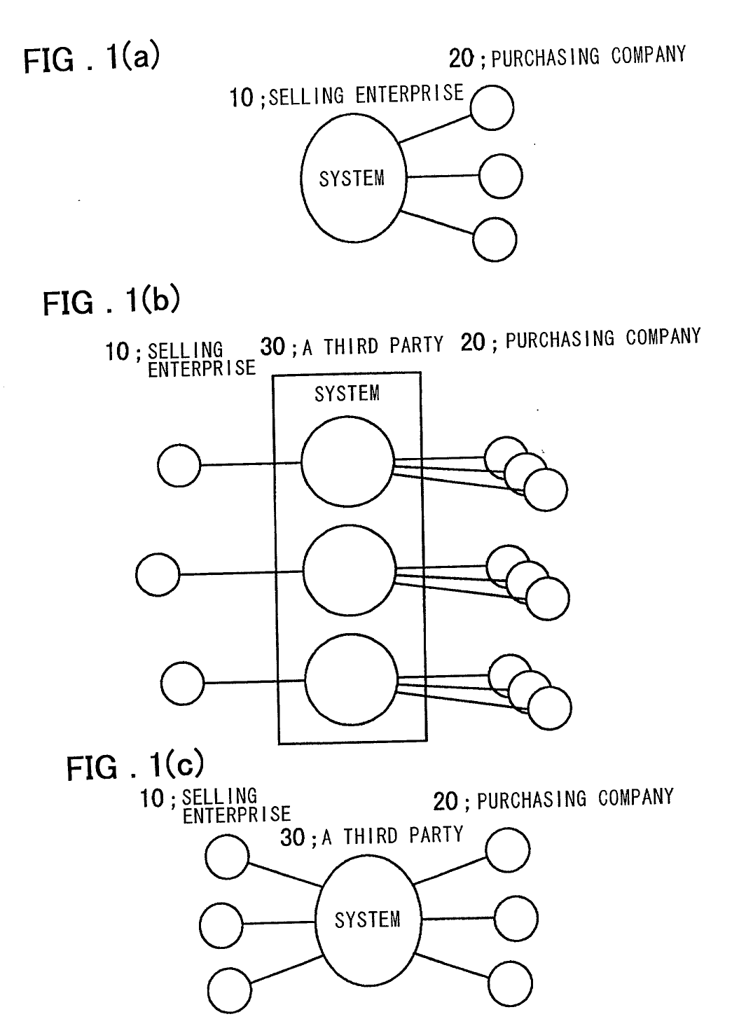

In a preferred embodiment of the present invention, one system is able to cope with the configuration of one seller for N purchasers, where N is a preset integer not less than 1 (see FIG. 1a)

In a preferred embodiment of the present invention, one system is able to cope with the configuration of M sellers for N purchasers, where M and N are each a preset integer not less than 2 (see FIGS. 1b and 1c).

The system proper may be held and managed by the selling enterprise, with the purchasing enterprise accessing the system.

Alternatively, the system proper may be managed by a third party, such as a server provider, in which case the selling and Purchasing enterprises access the system.

In an embodiment of the present invention, the electronic catalog information of the XML (eXtensibleMarkup Language) form is collected automatically and registered in the database of the system.

In an embodiment of the present invention, a retrieval configuration as retrieval for an electronic catalog from a client terminal is selected on user request from the condition retrieval, category retrieval and direct retrieval. In the category retrieval, the category is set to infinity to perform the retrieval.

In an embodiment of the present invention, a picture indicating the retrieved results may be assembled in XML responsive to the retrieved result.

In an embodiment of the present invention, a mail indicating the fact of data registration may be automatically transmitted to the selling enterprise at the time of registration of the request for estimation and of the ordering.

In an embodiment of the present invention, it may be selected freely in the estimation reply whether the estimation is to be made automatically from the system or the selling enterprise inputs the estimation reply information by way of a reply.

In an embodiment of the present invention, the ordering information, the information on the due term for delivery, and the state of shipment as the EDI (electronic data interchange) information of the XML system may be exchanged with the trunk system.

In an embodiment of the present invention, the present invention may be applied to a system for collecting and storing the marketing information. The accessing information to the system and the estimation information are stored for retrieval, referencing and analysis by the selling enterprise.

The present invention also provides a computer-readable program for causing a server system connected to a client for accessing to a database to execute processing steps (a) to (d):

(a) automatically collecting the information on articles of commerce, formulated by a seller, and which is rendered into an electronic form,

(b) receiving a request for a catalog of articles of commerce from a client terminal of the purchaser to retrieve the catalog information to return the result of retrieval to the client terminal,

(c) receiving the request for estimation from the client terminal to perform an automatic estimation of the articles of commerce to make a reply or of transmitting the contents of the estimation reply input by a person of the seller in charge to the client terminal of the purchaser, and

(d) receiving ordering data from the purchaser to transfer the ordering data as preset E-commerce information to the seller, receiving the information on the due term for delivery and the status of shipment output from the seller for storage in the database and transmitting the reply on the due term for delivery and the status of shipment responsive to a request from the client terminal of the purchaser.

It should be noted that the selling enterprise in a preferred embodiment of the present invention is not limited to an enterprise (body corporate) but may also be an organization or a private business entity offering various articles of commerce or services. The purchasing enterprise may also be an individual. The business model of the present invention may, of course, be applied to these various business owners or entities.

Referring to the drawings, certain preferred embodiments of the present invent ion are explained in detail. FIG. 1 shows a configuration of an embodiment of the present invention. There are three representative modes of carrying out the invention.

Referring to FIG. 1a, a selling enterprise 10 performs system management and itself acts as a selling enterprise to conduct commercial transactions with a purchasing enterprise 20.

Referring to FIG. 1b, a third party 30 performs system management and plural selling enterprises 20 exploit the same system to conduct commercial transactions individually.

Referring to FIG. 1c, the third party 30 performs system management and plural selling enterprises 20 exploit the same system to conduct commercial transactions together.

The users are roughly divided, by their attributes (authorization), into

a system supervisor;

a supplier manager;

a supplier user;

a buyer user; and

guest user.

The system supervisor has an authority of performing maintenance of the selling enterprise information and master maintenance of the selling enterprise information, in introducing a system 1 developed by applying the present invention. In case of a management by a third party, the system supervisor has the authority of managing the data quantity and the number of IDs.

The supplier manager is in the selling enterprise and has the authority of conducting maintenance of the information of no other than the selling enterprise registered by the system supervisor, maintenance of the supplier user information, maintenance of the buyer user and the guest user, maintenance of the information of the articles of commerce of the own company, management of the access log and retrieval of the articles of commerce of the own company.

The supplier user has the authority of the maintenance (password) of the own user information, registration, correction and deletion of the estimation information and of the registration, correction and deletion of the ordering information.

The buyer user has the authority of performing the maintenance of the own user information (password), retrieval of the articles of commerce, registration, correction and deletion of the estimation information and registration, correction and deletion of the ordering information.

The guest user has the authority of performing retrieval of the articles of commerce and referencing to the estimation information.

By hierarchizing the accessing authorizations of the supervisor and the user, as described above, safety of the system and the user is maintained.

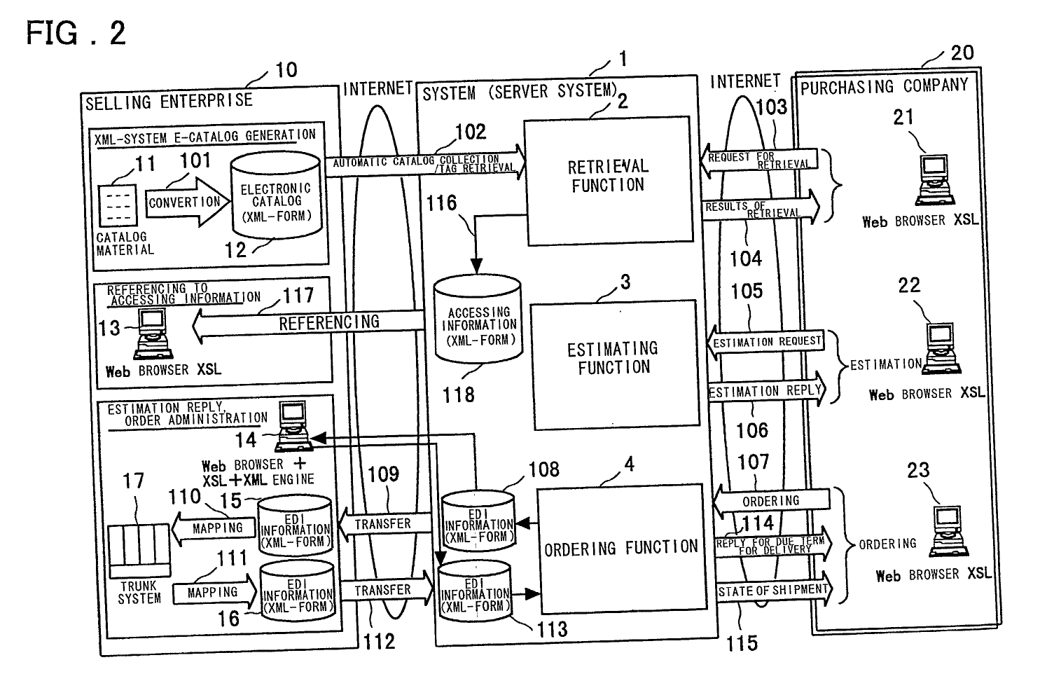

FIG. 2 shows the system configuration of an embodiment of the present invention.

The system configuration is made up of a business application executing environment, mounting a business flow modeled on the basis of the negotiation process in sale and of the ordering-order accepting process, a WWW server for demonstrating the result of execution processed on the business application execution environment, a database server for registering the information registered by the selling company and the customer 118, 108, 113, client computers 13, 14, 21, 23, which mounts a Web server and which can be connected to the Internet, an E-mail transmission/reception environment that can be exploited on a client computer, individual information, such as a sole ID or a password, for coping with the individual information, the information on the number of times of possible use preset in association with the individual information, and the registration information.

The user of the present system, authenticated by an ID, a password and so forth, previously allocated to each individual, is able to access the WWW server of the system from the client computer connected to the Internet, over the Internet, to utilize the functions as set for each ID, and the information permitted for accessing.

Referring more specifically to FIG. 2, the catalog information 11 of an article of commerce in a selling company 10 is converted into the XML form to generate the electronic catalog information 12 (step 102).

The server system 1 automatically collects the catalog information (step 102).

The purchasing enterprise 20 at a client terminal 21 accesses the server system 1 from the Web browser over the network (Internet) to perform catalog retrieval.

That is, the purchasing enterprise 20 issues to a retrieval function 2 of the server system 1 a retrieval request of an article of commerce (step 103), using condition retrieval, category retrieval and direct retrieval functions. The retrieval function 2 of the server system 1 retrieves the catalog information. The retrieval function 2 performs e.g., tag retrieval of XML of the electronic catalog information. That is, the retrieval function 2 retrieves a tagged document of XML having a start tag <element> and an end tag <element>. In the category retrieval, the category is set to infinity to render retrieval possible.

The purchasing company 20 at step S104 receives the results of retrieval by the retrieval function 2. It is possible to assemble picture data of results of retrieval conforming to the results of retrieval of the retrieval function 2 by XML.

The purchasing company 20 registers on a client terminal (computer) plural articles of commerce it desires to purchase to ask the estimation function 3 of the system to make estimation (step 105).

Responsive to the estimation request, the estimation function 3 automatically sets unit prices of articles of commerce registered at the outset on a screen by way of a reply (step 106). Alternatively, those in charge of sale of the selling enterprise confirm the contents of the estimation request to input the contents of the estimation response to make a reply (step 106). It is optional whether the reply for estimation is to be made automatically from the system or the selling enterprise is to input the estimation reply information by way of making a reply.

If the contents of the estimation reply is satisfactory for the purchasing company 20, the due term for delivery it desires, the payment condition and so forth are input to place an order to the ordering function 4 of the system 1 (step 107).

The ordering function 4 transfers the ordering data, as the EDI (electronic data interchange) information 108 of the XML system, to a trunk system 17 of the selling enterprise 10, such as a host computer.

At the time of registration of the request for estimation and of registration for ordering, an E-mail advising the fact of automatic data registration is automatically sent from the system 1 to the selling enterprise 10.

If matching to the message format of the trunk system 17 of the selling enterprise 10 is necessary, data mapping is performed (step 110).

The output information of the trunk system 17 of the selling enterprise 10, such as the information on the due term for delivery or the state of shipment, is mapped to a message format necessary for the system (step 111) for transfer to the system 1 (step 112). Control such as transfer of the EDI (electronic data exchange) information of the XML system, estimation reply or the processing for order acceptance is performed at a terminal 14 of the selling enterprise where a web browser and an XML (extensible style language) plus XML engine are installed.

The EDI information 113 of the XML system, transferred to the system 1, is stored on a database of the system 1 and the reply on the due term for reply 114 or the state of shipment 115 is displayed on request by a purchasing company 20.

The accessing information 118 on the selling enterprise 10 accessing the system or acquiring an estimation is stored in their entirety on a database of the system 1 (step 116). On request from the selling enterprise, the accessing information of the XML system 118 of the database may be referenced (step 117) for analysis.

That is, in an embodiment of the present invention, the information on negotiations and the information on the ordering and on the order acceptance can be analyzed, for use as the marketing information collection and storage system, from the terminal 13 of the selling enterprise to the web browser on which there is installed the XSL specifying the style for the XML document.

The meritorious effects of the present invent ion are summarized as follows.

According to the present invention, as described above, it is possible to overcome the constraint and inefficiencies of the conventional marketing system and to realize information exchange with more and more customers, shortened sale lead time, a reduced number of process steps and improved flexibility of the purchasing businesses on the part of customers by a simple and easy operation on the Internet.

According to the present invention, the selling enterprise is able to

1) enlarge the chance of sale;

2) improve the business efficiency; and

3) reduce the indirect cost,

such that an increasing sale amount may be expected by these effects.

As for the purchasing company, such effects as

1) improved convenience in selection of articles of commerce; and

2) more efficient purchasing operations may be achieved.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A system for exchanging the information on commercial transactions exploiting an electronic catalog comprising:
(a) means for collecting the catalog information, rendered in an electronic form, of the information on articles of commerce supplied by a seller;
(b) means for retrieving said catalog information responsive to a request for retrieval of an article of commerce from a purchaser to notify the results of retrieval to said purchaser;
(c) means for notifying an estimation reply for the article of commerce to said purchaser responsive to the estimation reply of the articles of commerce from the purchaser; and
(d) means for notifying reception of an order for an article of commerce from purchaser to said seller and for notifying the due term for delivery and/or the state/condition of shipment of the article of commerce to said purchaser, as necessary, based on the information from said seller.

2. A system for exchanging the information on commercial transactions exploiting an electronic catalog comprising:
(a1) a server system;
(a2) a client terminal of (a3) a seller and a client terminal of a purchaser, both connected over a network to said server system;
(b) means provided on said seller for storing the catalog information of the information on marketed articles of commerce, rendered in an electronic form; and
(c) means provided on said server system for automatically collecting said electronic catalog information, retrieving means, estimating means, ordering means and a database;
(d) said purchaser asking said retrieval means of said server system a request for retrieving a catalog of articles of commerce from said client terminal of the purchaser;
(e) said retrieving means retrieving said catalog information, with retrieved results being transmitted to said client terminal of the purchaser for display;
(f) said purchaser transmitting an estimation request of articles of commerce from said client terminal to said estimation means of said server system;
(g) said estimation means, on receipt of said estimation request making a reply as to the estimation of the article of commerce, or a person of the seller in charge inputting contents of the reply of the estimation, by way of making a reply, with the estimation reply being transmitted through said estimation means to said client terminal of the purchaser;
(h) said purchaser, on receipt of said estimation reply, transmitting ordering data, in placing an order for an article of commerce, from said client terminal of the purchaser to said ordering means of said server system;
(i) said ordering system transmitting data to said seller as the E-commerce information of a preset form, said ordering system receiving the information on the due term for delivery and the state/conditions of shipment output from said seller for storage in said database, said ordering system also making a reply on the due term for delivery and displaying the state/conditions of shipment on request from said purchaser.

3. The system for exchanging the information on commercial transactions exploiting an electronic catalog as defined in claim 2, wherein said server system as one system is capable of coning with the configuration of one seller for N purchasers, where N is a preset integer not less than 1.

4. The system for exchanging the information on commercial transactions exploiting an electronic catalog as defined in claim 2, wherein said server system as one system is capable of coping with the configuration of M sellers for N purchasers, where M and N are each a preset integer not less than 2.

5. The system for exchanging the information on commercial transactions exploiting an electronic catalog as defined in claim 2, wherein said server system is held, managed and supervised by said seller and is accessable by said purchaser.

6. The system for exchanging the information on commercial transactions exploiting an electronic catalog as defined in claim 2, wherein said server system is managed and supervised by a third party and is accessable by said purchaser.

7. The system for exchanging the information on commercial transactions exploiting an electronic catalog as defined in claim 2, wherein said server system automatically collects the electronic catalog information of the extensible markup language XML form to register the information in said database.

8. The system for exchanging the information on commercial transactions exploiting an electronic catalog as defined in claim 2, wherein a desired one selected from the group consisting of condition retrieval, category retrieval and direct retrieval is selected as the catalog retrieval from the client terminal of said purchaser.

9. The system for exchanging the information on commercial transactions exploiting an electronic catalog as defined in claim 8, wherein said category retrieval can be effected by setting the categories to an infinity.

10. The system for exchanging the information on commercial transactions exploiting an electronic catalog as defined in claim 2, wherein picture data for retrieved results corresponding to retrieved results by said retrieving means is assembled into an extensible markup language XML.

11. The system for exchanging the information on commercial transactions exploiting an electronic catalog as defined in claim 2, wherein a mail automatically advising said seller of the fact of data registration is transmitted to said seller at the time of registration of an estimation request and said order.

12. The system for exchanging the information on commercial transactions exploiting an electronic catalog as defined in claim 2, wherein, in making an estimation reply, selection may be made between said server system making an automatic reply and said seller inputting the estimation reply information to make a reply.

13. The system for exchanging the information on commercial transactions exploiting an electronic catalog as defined in claim 2, wherein the ordering information, due term information and the state/conditions of shipment as the electronic data interchange EDI information in the XML form is exchangeable to or from a trunk system of said seller.

14. The system for exchanging the information on commercial transactions exploiting an electronic catalog as defined in claim 2, wherein said seller is an enterprise selling articles of commerce and wherein said purchaser is an enterprise purchasing the articles of commerce.

15. A system for collecting and storing the marketing information, wherein the accessing information and the estimation information to a client terminal from a server system in the system for exchanging the information on commercial transactions exploiting an electronic catalog as defined in claim 2 are stored in said database and in which the stored information can be retrieved, referenced and analyzed from the terminal of said seller.

16. The system for exchanging the information on commercial transactions exploiting an electronic catalog as defined in claim 2, wherein the user accessing authorization is hierarchized into:
(1) a system supervisor authorized to take charge of the maintenance of the seller information and master maintenance required for system management and to supervise the data volume, number of IDs and so forth in case of management by a third party;
(2) a supplier supervisor authorized to take charge of the maintenance of the information on no other than the seller registered by said system supervisor, maintenance of the information on the buyer user and the guest user and the maintenance of the information on the articles of commerce of the own company, to supervise th access log of the own company and to retrieve the articles of commerce;
(3) a supplier user authorized to take charge of the maintenance of the own user information, to reference to a request for log management estimation of the own company and to the ordering information and to retrieve articles of commerce;
(4) a buyer user authorized to take charge of maintenance of the own user information and to perform retrieval of articles of commerce, registration, correction and deletion of the estimation information and registration, correction and deletion of the ordering information; and
(5) a guest user authorized to retrieve articles of commerce and to reference the estimation information; and,
wherein
accessing management is performed by authorization of the input user ID and the password.

17. A method for exchanging the information on the commercial transaction exploiting an electronic catalog comprising the steps of:
(a) preparing catalog information in an electronic form at the outset,
(b) performing negotiations and/or issuing/accepting an order between at least one seller and at least one purchaser by exchanging the information from respective client terminals on request for a retrieval estimation of articles of commerce and a corresponding reply in the marketing operations and the businesses of issuing/accepting an order of articles of commerce by taking advantage of functions of retrieval, estimation and ordering provided on a server.

18. A method for exchanging the information on the commercial transaction exploiting an electronic catalog comprising:
(a) a step of a seller generating the catalog information corresponding to the information on the articles of commerce on sale, said catalog information being in an electronic form;
(b) a step of a server system automatically collecting the catalog information in the electronic form;
(c) a step of a purchaser asking the retrieving function of said server system from a client terminal to retrieve a catalog of the articles of commerce desired to be purchased and receiving the result of catalog retrieval by said retrieving function;
(d) a step of said purchaser asking the retrieval function of said server system from the client terminal to make estimation of the articles of commerce desired to be purchased;
(e) a step of said server system making a reply on the estimation of the article of commerce responsive to the request for estimation by said purchaser or of a person of the seller in charge inputting contents of the reply on the estimation by way of making a reply;
(f) a step of said purchaser of the article of commerce or said purchaser receiving the reply on the estimation in ordering the article of commerce transmitting ordering data from the client terminal to the ordering mechanism of said server system;
(g) a step of said ordering function of said server system transferring said ordering data as preset E-commerce information to said seller;
(h) a step of said server system receiving the information on the due term for delivery or the state/conditions of shipment output from the seller to store the received information on the due term for delivery or the state of shipment in a database and displaying the reply on the due term for delivery or the state of shipment responsive to the request by said purchaser.

19. The method for exchanging the information on the commercial transaction exploiting an electronic catalog as defined in claim 18, wherein
said server system as one system is capable of coping with the configuration of one seller for N purchasers, where N is a preset integer not less than 1.

20. The method for exchanging the information on the commercial transaction exploiting an electronic catalog as defined in claim 18, wherein said server system as one system is able to cope with the configuration of M sellers for N purchasers, where M and N are each a preset integer not less than 2.

21. The method for exchanging the information on the commercial transaction exploiting an electronic catalog as defined in claim 18, wherein said server system is held, managed and supervised by a seller or sellers and is accessed by a purchaser or purchasers.

22. The method for exchanging the information on the commercial transaction exploiting an electronic catalog as defined in claim 18, wherein said server system is managed and supervised by a third party and is accessed by a purchaser or purchasers.

23. The method for exchanging the information on the commercial transaction exploiting an electronic catalog as defined in claim 18, wherein said server system automatically collects the electronic catalog information of the extensible markup language XML form to register the information in said database.

24. The method for exchanging the information on the commercial transaction exploiting an electronic catalog as defined in claim 18, wherein a desired one of the condition retrieval, category retrieval and direct retrieval is selected as the catalog retrieval from the client terminal of said purchaser.

25. The method for exchanging the information on the commercial transaction exploiting an electronic catalog as defined in claim 24, wherein said category retrieval can be effected by setting the categories to an infinity.

26. The method for exchanging the information on the commercial transaction exploiting an electronic catalog as defined in claim 18, wherein displayed data for retrieved results corresponding to retrieved results by said retrieving means is assembled into an extensible markup language XML.

27. The method for exchanging the information on the commercial transaction exploiting an electronic catalog as defined in claim 18, wherein a mail automatically advising said seller of the fact of data registration is transmitted to said seller at the time of registration of an estimation request and said order.

28. The method for exchanging the information on the commercial transaction exploiting an electronic catalog as defined in claim 18, wherein, in making an estimation reply, selection may be made between said server system making an automatic reply and said seller inputting the estimation reply information to make a reply.

29. The method for exchanging the information on the commercial transaction exploiting an electronic catalog as defined in claim 18, wherein the ordering information, due term information and the state/conditions of shipment as the electronic data interchange EDI information in the XML form is exchangeable to or from a trunk system of said seller.

30. The method for exchanging the information on the commercial transaction exploiting an electronic catalog as defined in claim 18, wherein said seller is an enterprise selling articles of commerce and wherein said purchaser is an enterprise purchasing the articles of commerce.

31. A system for collecting and storing the marketing information exploiting an electronic catalog as defined in claim 18, wherein the accessing information and the estimation information to a client terminal from a server system are stored in said database and in which the stored information can be retrieved, referenced and analyzed from the terminal of said seller.

32. A computer-readable program product for causing a server system, connected to a client accessable a database, to execute processing operation steps (a) to (d):
(a) automatically collecting the information on articles of commerce, formulated by a seller, and which is rendered into an electronic form;
(b) receiving a request for a catalog of articles of commerce from a client terminal of a purchaser to retrieve said catalog information to return a result of retrieval to said client terminal;
(c) (c1) receiving a request for estimation from said client terminal to perform an automatic estimation of the articles of commerce to make a reply; or
(c2) transmitting contents of the estimation reply input by a person of the seller in charge to said client terminal of the purchaser; and
(d) receiving ordering data from said purchaser to transfer the ordering data as preset E-commerce information to said seller, receiving the information on the due term for delivery and the status/conditions of shipment output from said seller for storage in said database and transmitting the reply on the due term for delivery and the status/conditions of shipment responsive to a request from said client terminal of the purchaser.
